(19) United States
(12) Patent Application Publication
(10) Pub. No.: US 2002/0033918 A1
(43) Pub. Date: Mar. 21, 2002

(54) Liquid crystal display device

(76) Inventors: Nobuyuki Shigeno, Tokyo (JP); Maki Tsuruta, Tokyo (JP); Yoshitoshi Kida, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/877,584

(22) Filed: Jun. 8, 2001

(30) Foreign Application Priority Data
Jun. 9, 2000 (JP) P2000-172885

(51) Int. Cl. G02F 1/1335

(52) U.S. Cl. 349/114

(57) ABSTRACT

Process of simplifying the manufacturing process and obtaining bright and high quality display for the semi-transmission type liquid crystal display device. The device has a liquid crystal panel of a transmission area having a transparent electrode as a pixel electrode as well as a reflection area having a reflector as a pixel electrode. The transparent electrode is formed of an ITO film while the reflector is formed of an Ag film which is directly formed on the ITO film. Also, the transparent electrode is provided directly on a transparent substrate of the liquid crystal panel. Or the gaps of mutually adjoining reflectors are shielded by a gate line, a signal line, or, simultaneously with formation of the gate line or the signal line, by a shield layer of the same materials as the gate line or the signal line.

### RELATED APPLICATION DATA

The present application claims priority to Japanese Application No. P2000-172885 filed Jun. 9, 2000, which application is incorporated by reference to the extent permitted by law.

### BACKGROUND OF THE INVENTION

1. Field of the Invention

The present invention relates to a liquid crystal display device and particularly to a panel structure of a semi-transmission type liquid crystal display device.

2. Description of the Related Art

Generally, display modes of a semi-transmission type liquid crystal display device may be roughly divided into a reflection type which utilizes external light to display reflected images and a transmission type which utilizes back light to display transmission images. Recently, such semi-transmission type liquid crystal display devices equipped with the properties of both types have been developed, in which one pixel is divided into a reflection mode area and a transmission mode area, whereas external light is used in a bright place to display reflected images in the reflection mode area and back light is used in a dark place to display transmission images in the transmission mode area.

FIG. 5 presents a plan view of positional relationships among a gate line, a signal line and a reflector electrode or a pixel electrode of a TFT (Thin Film Transistor) substrate 1 used for an ECB (Electrically Controlled Birefringence) semi-transmission type liquid crystal display device. The thickness of its liquid crystal layer is so adjusted for gap control that, in a transmission area T, there is a phase difference of approx. ?/2 between the electric field ON and the electrical field OFF, while in a reflection area R, there is a phase difference of approx. ?/4 between the electric field ON and the electrical field OFF. FIG. 4 is a cross-sectional view along the line x-x of the TFT substrate 1.

The TFT substrate 1 comprises a TFT device 3, a transparent electrode 4 composed of an ITO (Indium Tin Oxide) film 4x which is switching driven by the TFT device 3 and becomes a pixel electrode of the transmission area T, and a reflector electrode 5 comprising essentially of an Al film 17 which becomes a pixel electrode of the reflection area R. For example, the TFT substrate 1 can be manufactured on a glass substrate 2 in the following manner.

First, there is formed a metallic film such as Mo, Cr, Al, Ta or the like on a glass substrate 2, to which a dry etching process is applied by photolithography, as to form a gate line 6, a gate electrode G, and an auxiliary capacitance electrode Cs.

Next, as gate dielectric films, a silicon nitride (SiNx) film 7 and a silicon oxide (SiO₂) film 8 are layered successively, and an amorphous silicon film is further formed by a CVD (Chemical Vapor Deposition) process, the amorphous silicon film is then crystallized by means of a dehydrogenation anneal process to be turned into a poly-silicon film 9.

This is followed by forming a protective dielectric film made up of silicon oxide, whereupon an underside exposure is applied with the gate electrode G as a mask to pattern the resist formed thereon at a channel forming part in a manner of self-alignment with the gate electrode G. This resist is further used as a mask for etching the protective dielectric film, whereby a protective dielectric film 10 is left at the channel forming part upon the gate electrode, whereupon a dopant is injected with the protective dielectric film 10 as a mask to form an LDD (Lightly Doped Drain) region.

Subsequently, a resist mask for injecting into a N channel source and drain is formed from a photo-resist, then a dopant is injected into the N channel source and drain region and the auxiliary capacitance region. When a C-MOS (Complementary Metal Oxide Semiconductor) circuit is to be formed, a mask for injecting into a P channel source and drain is further formed from the photo-resist, the dopant is injected into the P channel forming region, then a heat anneal process such as a RTA (Rapid Thermal Annealer) is used to activate the dopant.

The next step is the stripping process of unnecessary portions other than the TFT forming part, that is, the protective dielectric film and the poly-silicon film, by wet etching or dry etching using photolithography.

Then, the process of forming successively a silicon nitride film 11 and a silicon oxide film 12 as interlayer dielectric films by the CVD process follows. And hydrogenation annealing is performed to improve the performance of the TFT device 3 by diffusing hydrogen in the poly-silicon film.

A contact hole is then produced, succeeded by forming a Ti film by sputtering and also forming an Al film by sputtering, the Ti film and the Al film subjected to patterning by dry etching using photolithography, all these steps leading to formation of a signal line 13 connected to a source electrode S and a drain electrode D.

Now, a scattering layer 14 is formed of a resist, then subjected to patterning by means of photolithography, whereupon a planar layer 15 comprising acryl resin or the like is further formed and patterned by photolithography.

Next, in order to form a transparent electrode (ITO electrode) 4 which will become a pixel electrode of the transmission area T, the ITO film 4x is formed by the sputtering process and subjected to patterning by photolithography.

In addition, in order to form the reflector 5 which will become the pixel electrode of the reflection area R, a Ti film is formed on the ITO film 4x by sputtering, and next an Al film 17 is formed by sputtering, whereas, by subjecting the Ti film 16 and Al film 17 to a wet etching process through photolithography, the Ti film 16 and the Al film 17 are stripped to form a transmission aperture 20.

There is held a liquid crystal between the TFT substrate 1 thus manufactured and the opposite electrode (not shown), constituting a liquid crystal panel.

As described above, in the TFT substrate 1 used in the conventional semi-transmission type liquid crystal display device, the reflector 5 is formed of the Al film 17, on the underside of which the Ti film 16 is disposed. This is because the ITO film and the Al film do not form an ohmic contact, so the Ti film is interposed between the two materials to make the possible ohmic contact. Nevertheless, as a result, formation of the Ti film 16 makes the manufacturing process of the reflector 5 a complicated one.

To enable the reflector 5 composed of the Al film 17 and the transparent electrode 4 to make an ohmic contact, use of In₂O₃ (IXO of Idemitsu Kosan or the like) may be considered in place of ITO as the forming material of the transparent electrode 4. But, if In₂O₃ is used to form the transparent electrode 4, when the Al film 17 is stripped by etching to open the transmission aperture 20, the etchant for the Al film would cause damage to the In₂O₃ film, and deteriorates its expressed quality. Consequently, even if the In₂O₃ film is used in place of the ITO film, to protect the transparent electrode 4 from any damage caused by stripping the Al film 17 through etching, it is necessary to provide a passivation film such as SiNx between the In₂O₃ film and the Al film 17. In the final analysis, this means that since the film-forming process of SiNx as well as the etching process using photolithography are necessary, there is no way for the manufacturing process to be simplified.

It should be mentioned that the silicon nitride film 11 and the silicon oxide film 12 are present in the transmission aperture 20 as interlayer dielectric films, interference of which contributes to deteriorating the transmittance when displaying a transmission image to cause a lack of brightness of the screen.

Furthermore, on the TFT substrate of the semi-transmission type liquid crystal display device, it is necessary to shield from light a space between the adjacent reflector electrodes 5, wherefore in the conventional liquid crystal TFT substrate 1, a shielding region composed of carbon black, Cr and other materials is provided in the opposite electrode, whilst formation of the shielding region in the opposite electrode causes incident light from the oblique direction when displaying a reflected image or light issuing to the oblique direction to be absorbed thereby, leading to problems of significantly decreasing the reflection factor and darkening the screen.

The present invention purports to resolve the foregoing problems inherent in the currently available technology. Therefore, it is the primary object of the present invention to provide a transmission-type liquid crystal display device which may be manufactured in simplified processing steps and is capable of rendering the bright, high quality display.

### SUMMARY OF THE INVENTION

To these ends mentioned above, firstly, the present invention provides a semi-transmission type liquid crystal display device having a transmission area provided with a transparent electrode as a pixel electrode and a reflection area provided with a reflector as a pixel electrode in its liquid crystal panel, wherein the transparent electrode in the transparent area comprises an ITO film while the reflector in the reflection area comprises an Ag film directly formed on the ITO film. In addition, the present invention provides a manufacturing process of the semi-transmission type liquid crystal display device having the transmission area provided with the transparent electrode as the pixel electrode and the reflection area provided with the reflector as the pixel electrode in its liquid crystal panel, wherein, after the ITO film is formed as the transparent electrode of the transparent area and subjected to patterning, the Ag film is formed directly upon the ITO film, which is then subjected to patterning to form the reflector of the reflection area.

Secondly, the present invention provides the semi-transmission type liquid crystal display device having the transmission area provided with the transparent electrode as the pixel electrode and the reflection area provided with the reflector as the pixel electrode in its liquid crystal panel, wherein the transparent electrode of the transparent area is provided directly on the transparent substrate of the liquid crystal panel.

Thirdly, the present invention provides the semi-transmission type liquid crystal display device having the transmission area provided with the transparent electrode as the pixel electrode and the reflection area provided with the reflector as the pixel electrode in its liquid crystal panel, wherein gaps between the adjacent reflectors are shielded by a shielding layer formed of a gate line and a signal line or the same material as the gate line or the signal line when the gate line or the signal line is formed.

In the first feature of the present invention, since the Ag film constituting the reflector forms an ohmic contact with the ITO film, the Ag film can be formed directly on the ITO film without interposition of the Ti film, thus making it possible to simplify the manufacturing process of the reflector. Also, as regards the etching conditions of the Ag film when the transmission aperture is opened, because a sufficient difference of the etch rates can be established between the Ag film and the ITO film without damaging the ITO film, the Ag film can be stripped and the transmission aperture can be opened, thereby achieving an improvement of the image quality when an transmission images are displayed.

Further, according to the second feature of the present invention, inasmuch as the transparent electrode of the transparent area can be set up directly on the transparent substrate of the liquid crystal panel, there is none of the drawbacks of the existing semi-transmission liquid crystal display device with the transparent electrode being formed on the interlayer dielectric films (a silicon nitride film and a silicon oxide film), interference of which adversely affects the transmission image. Another advantage is a bright display of transmission images by virtue of the gap control of the transparent area.

Moreover, according to the third feature of the present invention, an improvement is attained by making it possible to shield the gaps between the adjacent reflectors by dispensing with any need of forming a shielding region on the opposite substrate, wherefore, when reflective images are displayed, light is not absorbed to the unnecessary extent in the shielding region of the opposite substrate. As a result, the reflective image can be brightly displayed.

There is an additional gain brought about by shielding the gaps between the adjacent reflectors by virtue of forming the gate line or the signal line wider in width, or simultaneously with the formation of the gate line or the signal line, by virtue of a shielding layer formed of the same material as any of the lines. Consequently, without providing a separate process of forming the shielding layer, the gaps between the reflectors can be shielded. In this manner, the semi-transmission type liquid crystal display device according to the present invention makes it possible to simplify the manufacturing process thereof and enhance contrast when the transmission images are displayed.

### BRIEF DESCRIPTION OF THE DRAWINGS

In the accompanying drawings:

FIG. 1 is a cross-sectional view of a TFT substrate (TFT substrate of FIG. 2) used for a semi-transmission type crystal display device according to the present invention;

FIG. 2 is a plan view showing positional relationships among a gate line, a signal line, and a reflector of the TFT substrate used for the semi-transmission type crystal display device according to the present invention;

FIG. 3 is a plan view showing positional relationships among the gate line, the signal line, and the reflector of the TFT substrate used for the semi-transmission type crystal display device according to the present invention;

FIG. 4 is a cross-sectional view taken on line x-x of the TFT substrate (TFT substrate of FIG. 5) used for the conventional semi-transmission type liquid crystal display device; and

FIG. 5 is a plan view showing positional relationships among the gate line, the signal line, and the reflector of the TFT substrate used for the conventional semi-transmission type crystal display device.

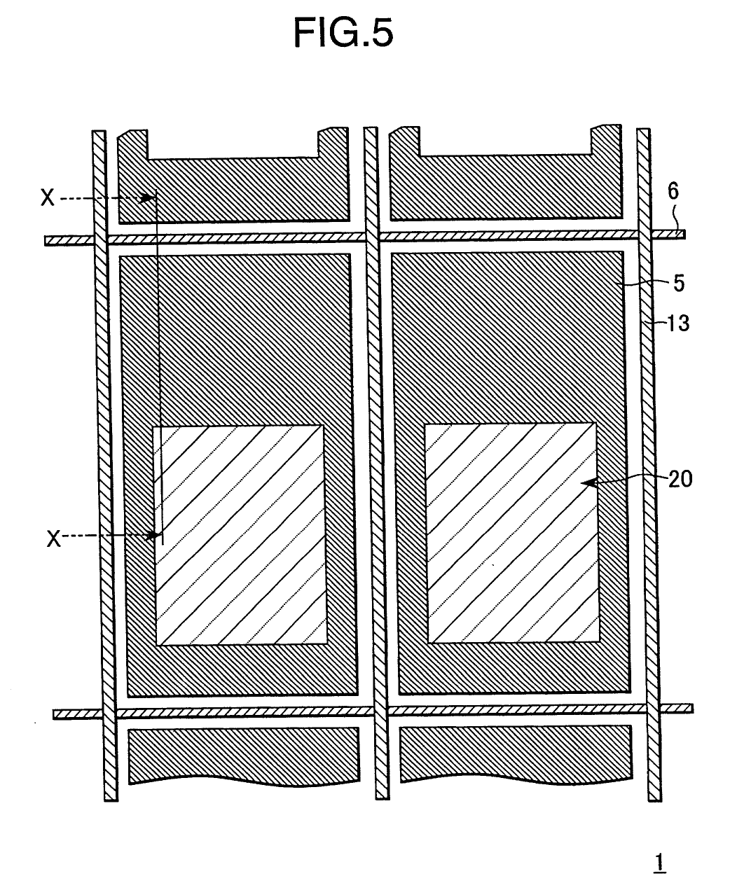

### DETAILED DESCRIPTION OF THE PREFERRED EMBODIMENT

A preferred embodiment of the present invention will be described in detail with reference to the accompanying drawings. The same reference characters in each drawing represents the same or equivalent structural element.

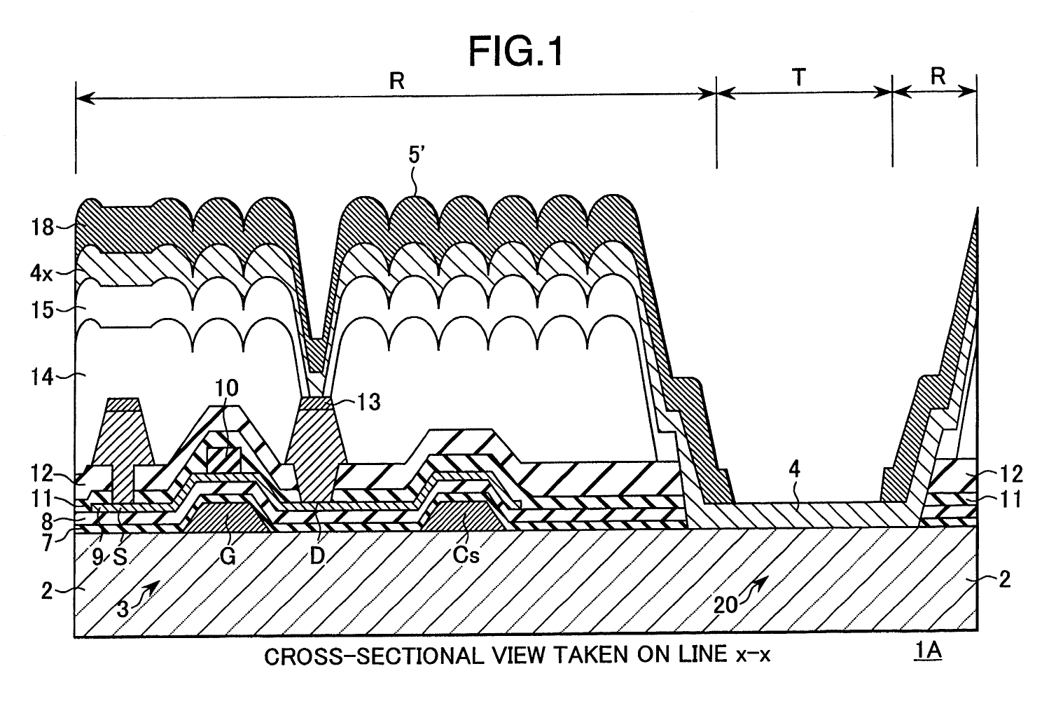

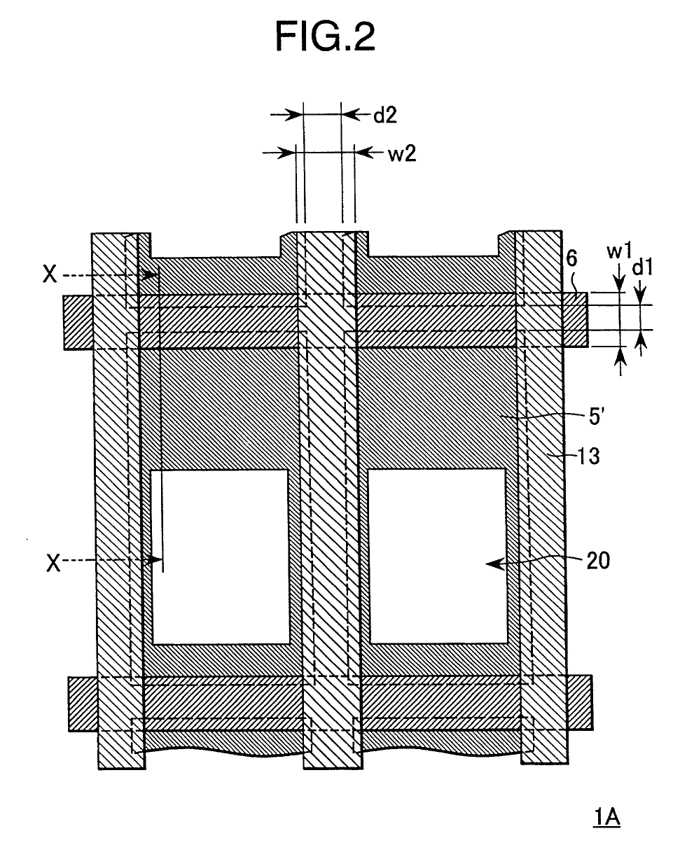

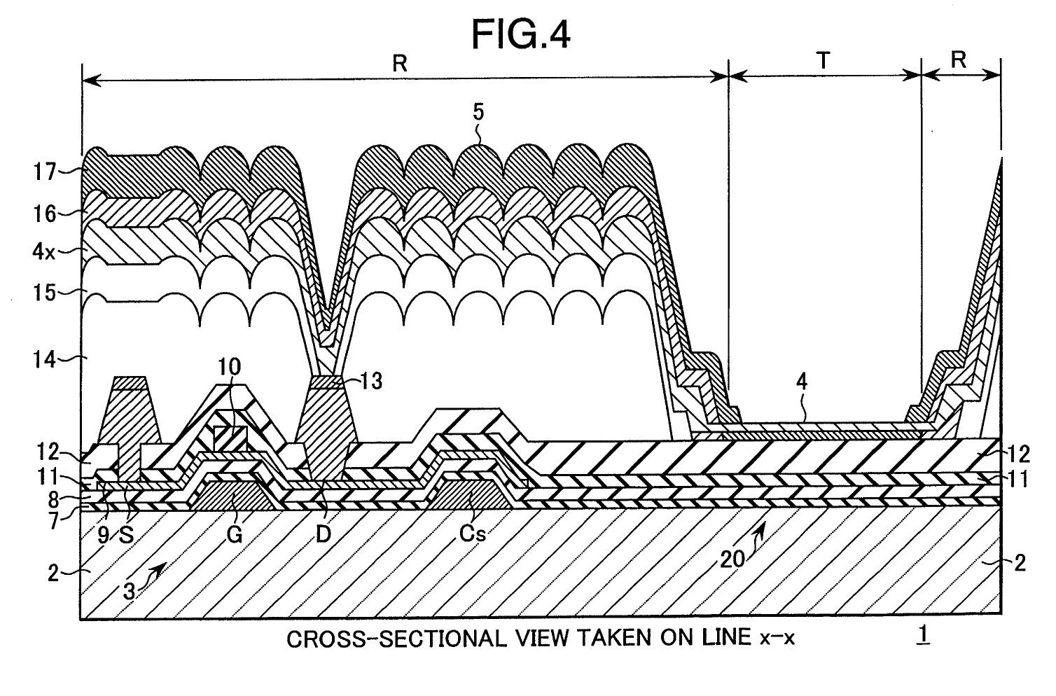

Like a TFT substrate of FIG. 4, there is shown in FIG. 2 a plan view of positional relationships among a gate line, a signal line and a reflector (pixel electrode) of a TFT substrate 1 of the preferred embodiment of the present invention used for an ECB (Electrically Controlled Birefringence) semi-transmission type liquid crystal display device with the thickness of its liquid crystal layer subjected to gap control so that, in the transmission area T, there is a phase difference of approx. ?/2 between the electric field ON and the electrical field OFF, while in the reflection area R, there is a phase difference of approx. ?/4 between the electric field ON and the electrical field OFF. FIG. 1 is a cross-sectional view of the TFT substrate 1A along the line x-x.

The first feature of the TFT substrate 1A is that, in contrast to the reflector 5 consisting essentially of an Al film 17 in the conventional TFT substrate 1, the reflector 5′ is formed of an Ag film 18, and that the reflector 5′ is directly set up on an ITO film 4x with no inter-disposition of a Ti film.

The second feature thereof is that, in the transmission area T, the transparent electrode 4 is directly formed on a glass substrate 2 with no inter-disposition of gate dielectric films 7 and 8 and interlayer dielectric films 11 and 12 between the transparent electrode 4 and the glass substrate 2.

The third feature thereof is that a width w1 of the gate line 6 and a width w2 of a signal line 13 are wider than widths d1 and d2 of the gaps between the adjacent reflectors 5′, and that the gaps of the adjacent reflectors 5′ are shielded by the gate line 6 and the signal line 13.

A structure which forms the first feature of the TFT substrate 1A may be, for example, arranged as follows. First, like the conventional TFT substrate 1, the ITO film 4x is formed by sputtering or any other similar process to a thickness of 20 to 300 nm and treated to wet etching by photolithography into a prescribed pattern, whereas the next step of annealing is applied to the ITO film 4x, and followed by formation of the Ag film 18 by sputtering or any other similar process to a thickness of 0.1 to 1.0? m on the ITO film 4x, then the wet etching by photolithography succeeds, thus opening a transmission aperture 20.

At this point, note that it is preferable to perform annealing of the ITO film 4x for a period of 0.5 to 5 hours at 100 to 300° C. This sufficiently promotes crystallization of ITO, preventing the ITO film 4x from being damaged at the subsequent wet etching step of the Ag film 18.

In addition, the wet etching of the Ag film 18 is to be processed, for instance, using an etchant of a mixture of acids (phosphoric acid, nitric acid, acetic acid=60%, 2.9%, 10.5%) for a period of time not more than 1 minute at 20 to 40° C.

Direct formation of the Ag film 18 on the ITO film 4x in this manner contributes to simplifying the manufacturing process of the TFT substrate.

On the other hand, formation of a structure comprising the second feature of the TFT substrate 1A may be rendered as follows: in the manufacturing process of the conventional TFT substrate 1, after a planar layer (PLN) 15 is formed, when patterning the planar layer 15, the gate dielectric films 8 and 8, the interlayer dielectric films 11 and 12, and a scattering layer 14 laminated on the glass substrate 2 in the transmission area T are all stripped by etching, the substrate 2 being further subjected to etching, as necessary, for the prescribed amount. Thereafter, the ITO film 4x is formed. Without increasing the number of processing steps of the TFT substrate, this prevents the display of transmission images from getting dark due to interference of the interlayer dielectric films 11 and 12 on the glass substrate 2, further contributing to improving the gap control of the transmission area T, so that the display of transmission images can be made even brighter.

A structure marked by the third feature of the TFT substrate 1A is accomplished in the manufacturing process of the conventional TFT substrate by modifying part of the conventional processing steps by virtue of making the width w1 of the gate line 6 and the width w2 of the signal line 13 wider than the widths d1 and d2 of the gaps between the adjacent reflectors 5′, thereby shielding the gaps there-between. Without increasing the number of processing steps of the TFT substrate, this shields the gaps there-between and increases a contrast when transmission images are displayed.

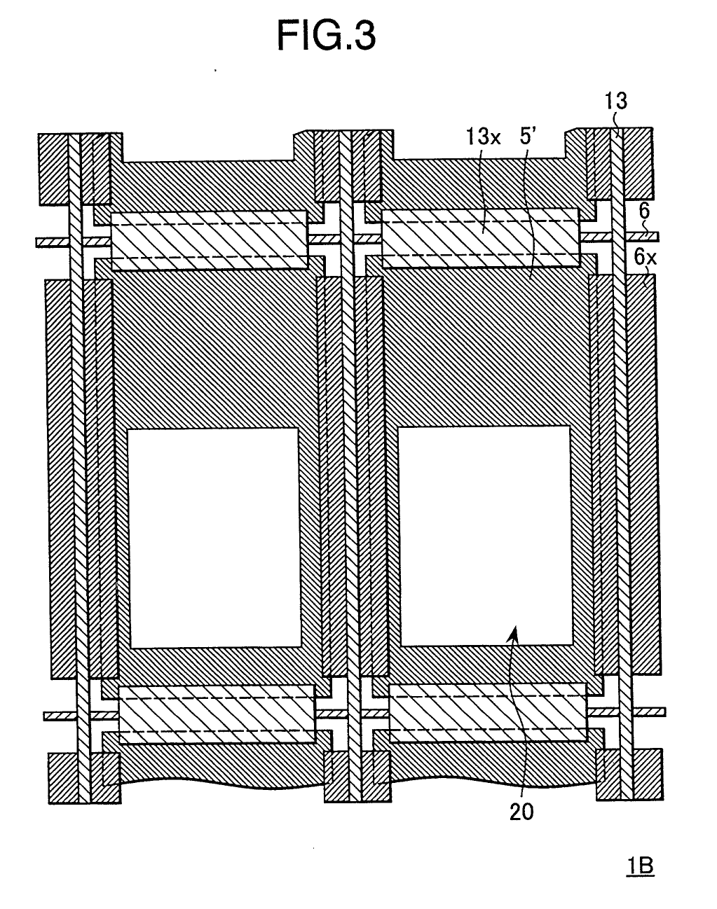

FIG. 3 shows the positional relationships among the gate line, signal line, and the reflector of the TFT device 1B which is a modification explained in the third feature of the present invention. Although the gate line 6 and the signal line 13 themselves are not formed in broad widths in this TFT device 1B, simultaneously with the formation of the gate line 6, a shielding layer 6x is formed of the same forming materials as the gate line, and the gaps of the adjacent reflectors 5′ are shielded by the shielding layer 6x, whereas, simultaneously with the formation of the signal line 13, a shielding layer 13x is formed of the same forming materials as the gate line, and the gaps of the adjacent reflectors 5′ are shielded by the shielding layer 13x. These shielding layers 6x and 13x can be considered as the gate line or the signal line formed at a floating potential.

While referring to the drawings, the present invention has been described with respect to the embodiment. Furthermore, many modifications and variations of the present invention are possible in light of the above teachings. For example, while the TFT substrate 1A shown in FIG. 1 and FIG. 2 includes all the first to the third features of the present invention, so long as any one of the first, second, and third features is included in the TFT substrate 1A, any semi-transmission type liquid crystal display device functions properly as the semi-transmission type liquid crystal display device according to the present invention, or a combination of any two features is also acceptable. It should be mentioned that the semi-transmission type liquid crystal display device according to the present invention is also applicable to the liquid crystal display devices other than the ECB mode.

According to the first feature of the present invention, formation of the reflector directly on the ITO film without any inter-disposition of the Ti film as well as the passivation film enables the manufacturing process to be simplified.

Further, according to the second feature of the present invention, the transparent electrode is directly provided on the substrate in the transmission area, so that it is possible to improve the transmittance when displaying transmission images without increasing the number of processing steps, and that the gap control in the transmission area T can also be enhanced.

Moreover, according to the third feature of the present invention, shielding of the gaps between the adjacent reflectors can be attained without providing a shielding region in the opposite substrate and without increasing the number of processing steps of the TFT substrate, thereby improving a contrast when transmission images are displayed.

What is claimed is:

1. A semi-transmission type liquid crystal display device having a transmission area provided with a transparent electrode as a pixel electrode and a reflection area provided with a reflector electrode as a pixel electrode in a liquid crystal panel thereof, wherein said transparent electrode of the transparent area being formed of an ITO film; and
said reflector electrode of the reflection area being formed of an Ag film directly formed on said ITO film.

2. A manufacturing process of a semi-transmission type liquid crystal display device having a transmission area provided with a transparent electrode as a pixel electrode and a reflection area provided with a reflector electrode as a pixel electrode in the liquid crystal panel comprising the steps of:
forming an ITO film as said transparent electrode of the transmission area;
patterning said ITO film;
forming an Ag film directly on said ITO film; and
patterning said Ag film as to form said reflector electrode of the reflection area.

3. A semi-transmission type liquid crystal display device having a transmission area provided with a transparent electrode as a pixel electrode and a reflection area provided with a reflector electrode as a pixel electrode in a liquid crystal panel, wherein
said transparent electrode of the transparent area is provided directly on a transparent substrate of the liquid crystal panel.

4. A semi-transmission type liquid crystal display device having a transmission area provided with a transparent electrode as a pixel electrode and a reflection area provided with a reflector as a pixel electrode in a liquid crystal panel, wherein
gaps of adjacent reflector electrodes being optically shielded by a shielding layer.

5. A semi-transmission type liquid crystal display device as cited in claim 4, wherein
formed of a gate line, a signal line or simultaneously with formation of the gate line or the signal line, same materials as the gate line or the signal line.
